(19) United States
(12) Patent Application Publication
(10) Pub. No.: US 2014/0312729 A1
(43) Pub. Date: Oct. 23, 2014

(54) MOTOR HAVING INTEGRAL STATOR CORE

(71) Applicant: AMOTECH CO., LTD., Incheon (KR)

(72) Inventors: Byung Soo Kim, Anyang-si (KR); Se Ki Lee, Incheon (KR)

(73) Assignee: AMOTECH CO., LTD., Incheon (KR)

(21) Appl. No.: 14/360,053

(22) PCT Filed: Dec. 12, 2012
(86) PCT No.: PCT/KR2012/010794

§ 371 Date: May 22, 2014

(30) Foreign Application Priority Data
Dec. 22, 2011 (KR) 10-2011-0140091

(51) Int. Cl. H02K 1/16

(52) U.S. Cl. CPC H02K 1/165
USPC 310/112

(57) ABSTRACT

Provided is a motor having an integral stator core, which includes: stators including a plurality of split stator cores that are annularly disposed, bobbins that are surrounded on respective outer circumferential surfaces of the stator cores, and coils wound on an outer circumferential surface of each bobbin; and rotors that are arranged with a gap from each stator, in which the stator core is integrally molded to include a yoke around which the coils are wound, and a first flange and a second flange that are formed at both ends of the yoke, and in which coil winding grooves that are formed at height lower than those of the upper and lower surfaces of the first and second flanges, are formed on the upper and lower surfaces as well as the left and right surfaces of the yoke in order to reduce height of the stator core, to thereby enable the motor to be slimmed.

### TECHNICAL FIELD

The present invention relates to a motor having an integral stator core in which a stator core is integrally molded by compressively molding a mixture of amorphous metal powder and soft magnetic powder, amorphous metal powder alone, or soft magnetic powder alone, to thereby simplify a manufacturing process and to thus reduce a height of the motor to enable the motor to be slimmed

### BACKGROUND ART

Slotted stators cause difficult windings, require a lot of time for winding operations, and require complex and expensive coil winding equipment. Also, a structure formed of a number of teeth induces a magnetic discontinuity, to thus affect the efficiency of a motor, and generate a cogging torque depending on the presence of slots. In the case of a material such as an electric steel plate, the thickness of the electric steel plate is thick, to accordingly increase an iron loss, and exhibit the low efficiency in high-speed motors.

Many of devices that are being used in a variety of fields, including the latest technology of high-speed machine tools, air motors, actuators, and compressors, require electric motors exceeding 15,000 to 20,000 rpm, and, in some cases, electric motors that may operate at high speed up to 100,000 rpm. Almost all of the high-speed electric devices are manufactured to have a low magnetic polarity factor. This is to ensure to prevent magnetic bodies in electric devices that operate at high frequencies from having an overly excessive core loss. The main cause is due to the fact that soft magnetic bodies used in most of the motors are composed of Si—Fe alloys. In conventional Si—Fe-based materials, a loss caused by a changing magnetic field at a frequency of about 400 Hz or more may heat the Si—Fe-based materials until the materials cannot be often cooled by even any suitable cooling devices.

Until now, it has been known that it is very difficult to provide electric devices that are easily manufactured while taking the advantages of low-loss materials, at a low-cost. Most of attempts of applying the low-loss materials in the conventional devices have failed. This was due to the reason why the initial designs relied on simple replacement in which conventional alloys such as Si-Fe were replaced by new soft magnetic substances such as amorphous metal, in the magnetic cores of the devices. These electric devices show improved efficiency with low losses, from time to time, but may raise general problems of causing a severe deterioration of the output, and big costs related to molding and handling of amorphous metal. As a result, commercial success or market entry did not occur.

Meanwhile, the electric motor typically includes a magnetic member formed of a number of stacked laminates of non-oriented electric steel plates. Each laminate is typically formed by stamping, punching, or cutting mechanically soft non-oriented electric steel pates in a desired shape. The thus-formed laminates are sequentially stacked to form a rotor or stator having a desired form.

When compared with the non-oriented electric steel plates, an amorphous metal provides excellent magnetic performance, but has been considered for a long time that it is unsuitable to be used as a bulk magnetic member such as a rotor or stator for electric motors, because of certain physical properties and obstacles that occur at the time of fabrication.

For example, the amorphous metal is thinner and lighter than the non-oriented electric steel plate, and thus a fabrication tool and die will wear more rapidly. When compared with the conventional technology such as punching or stamping, fabrication of the bulk amorphous metal magnetic member has no commercialized competitiveness due to an increase in fabrication costs for the tools and dies. Thin amorphous metal also leads to an increase in the number of the laminates in the assembled member, and also increases the overall cost of the amorphous metal rotor or stator magnet assembly.

The amorphous metal is supplied in a thin, continuous ribbon having a uniform ribbon width. However, the amorphous metal is a very mild material, and thus it is very difficult to cut or mold the amorphous metal. If the amorphous metal is annealed in order to obtain the peak magnetic characteristics, an amorphous metal ribbon is noticeably brittle. This makes it difficult to use conventional methods to configure the bulk amorphous magnetic member, and also leads to a rise in the cost. In addition, embrittlement of the amorphous metal ribbon may bring concerns about the durability of the bulk magnetic member in an application for an electric motor.

From this viewpoint, Korean Patent Laid-open Publication No. 2002-63604 proposed a low-loss amorphous metal magnetic component having a polyhedral shape and a large number of amorphous strip layers for use in high efficiency electric motors. The magnetic component may operate in a frequency range of about 50 Hz to about 20,000 Hz, while having a core loss so as to indicate the enhanced performance characteristics in comparison with the Si—Fe magnetic component that operates in the same frequency range, and has a structure that is formed by cutting an amorphous metal strip to then be formed into a number of cut strips having a predetermined length and laminating the cut strips using epoxy in order to form a polyhedral shape.

However, the Korean Patent Laid-open Publication No. 2002-63604 discloses that brittle amorphous metal ribbon is still manufactured via a molding process such as cutting, and thus it is difficult to make a practical application. In addition, the Korean Patent Laid-open Publication No. 2002-63604 discloses that the magnetic component may operate in a frequency range of about 50 Hz to about 20,000 Hz, but did not propose an application for higher frequency.

Meanwhile, Korean Patent Laid-open Publication No. 2005-15563 discloses a method of manufacturing amorphous soft magnetic cores, which includes the steps of: preliminary-heat-treating an amorphous metal ribbon prepared by a rapid solidification method by using a Fe-based amorphous alloy; pulverizing the amorphous metal ribbon to thus obtain amorphous metal powder; classifying the amorphous metal powder to then mix the classified amorphous metal powder in a powder particle size distribution having an optimum composition uniformity; mixing the mixed amorphous metal powder with a binder, to then mold cores; and annealing the molded cores to then coat the molded cores with an insulating resin.

The cores are used in a smoothing choke core for a switching mode power supply (SMPS) for the purpose of improving direct current superposition characteristics of magnetic cores with respect to a waveform where a direct current is superimposed on a weak alternating current that is generated in the process of converting an AC input of a power supply to a DC output.

In addition, Korean Patent Registration No. 721501 discloses a method of manufacturing nanocrystalline soft magnetic alloy powder cores, which includes the steps of: preliminary-heat-treating an amorphous alloy ribbon; classifying powder that is obtained by pulverizing amorphous alloy powder that is obtained by pulverizing the preliminary-heat-treated amorphous alloy ribbon; mixing the powder having a predetermined particle size among the classified powder with a binder of a polyimide-based resin; pressing the mixed powder; and heat-treating the pressed powder for nano-crystallization of cores of the pressed powder.

The powder cores are applied to current transformers, circuit breakers, and smoothing chokes that are used for large power.

Meanwhile, in the case that a high-speed motor of a high output of 100 kW and 50,000 rpm is implemented by using silicon steel plates as in drive motors for electric vehicles, an eddy current increases due to high-speed rotation, and thus a problem of generating heat may occur. Also, since the drive motors for electric vehicles are fabricated in a large size, it is not possible to apply the drive motors to the driving system of the in-wheel motor structure, and it is undesirable in terms of increasing weight of the vehicles.

In general, the amorphous strip has a low eddy current loss, but conventional motor cores that are made by winding, molding, and laminating amorphous strips may cause it to be difficult to make a practical application due to difficulties of a manufacturing process as pointed out in the prior art. As described above, the conventional amorphous strips provides superior magnetic performance compared to non-oriented electrical steel plates, but are not applied as the bulk magnetic members such as stators or rotors for electric motors because of obstacles that occur during processing for the manufacture.

In addition, the conventional method of manufacturing the amorphous soft magnetic core did not present a method of designing a magnetic core optimal in the field of an electric motor with a high-power, high-speed, high-torque, and high-frequency characteristics.

In addition, the need for improved amorphous metal motor members indicating the excellent magnetic and physical properties required for high-speed, high-efficiency electrical appliances is on the rise. Development of manufacturing methods of efficiently using the amorphous metal and practicing mass-production of a variety of types of motors and magnetic members used for the motors is required.

### Technical Problem

To solve the above problems or defects, it is an object of the present invention to provide a motor having an integral stator core in which the stator core is integrally fabricated by compression-molding amorphous metal powder, soft magnetic powder, or a mixture of amorphous metal powder and soft magnetic powder, to thereby reduce a core loss to thus reduce a manufacturing cost of the motor, reduce a mold manufacturing cost thereof, and simplifying a manufacturing process thereof.

It is another object of the present invention to provide a motor having an integral stator core in which the stator core is integrally molded and coil winding grooves are formed on the upper and lower surfaces as well as the left and right surfaces of the stator core on which coils are wound, to thereby reduce height of the stator core, and to thus enable the motor to be slimmed

It is still another object of the present invention to provide a motor having an amorphous core in which a yoke and a flange are separately manufactured and then assembled with each other to thereby make a stator core and to thus provide the stator core in various forms.

The other objects of solving the technical problems of the present invention are not limited to the objects of solving the above-mentioned problems, and it will be clearly understood from the following description by one of ordinary skill in the art that there will be other objects of the present invention.

### Technical Solution

To accomplish the above and other objects of the present invention, according to an aspect of the present invention, there is provided a motor having an integral stator core, the motor comprising: stators including a plurality of split stator cores that are annularly disposed, bobbins that are surrounded on respective outer circumferential surfaces of the stator cores, and coils wound on an outer circumferential surface of each bobbin; and rotors that are arranged with a gap from each stator, wherein each of the stator cores is integrally molded to include a yoke around which the coils are wound, and a first flange and a second flange that are respectively formed at both ends of the yoke, and wherein coil winding grooves that are formed at height lower than those of the upper and lower surfaces of the first and second flanges, are formed on the upper and lower surfaces as well as the left and right surfaces of the yoke in order to reduce height of the stator core.

Preferably but not necessarily, each rotor comprises: an outer rotor that is arranged with a gap on an outer circumferential surface of the stator; an inner rotor that is arranged with a gap on an inner circumferential surface of the stator; and a rotor support to which the outer rotor and the inner rotor are fixed and to which a rotating shaft is supported.

Preferably but not necessarily, the coil winding grooves comprise: a first coil winding groove that is formed on top of or on the left surface of the yoke, and that is recessed by a depth HI inwardly from the top surfaces of the first flange and the second flange; and a second coil winding groove that is formed on bottom of or on the right surface of the yoke, and that is recessed by a depth H2 inwardly from the top surfaces of the first flange and the second flange.

Preferably but not necessarily, one or both the first flange and the second flange and the yoke are separately manufactured and mutually assembled.

Preferably but not necessarily, the stator core is compression-molded by using amorphous metal powder, or by using a mixture of amorphous metal powder and spherical soft magnetic powder.

### Advantageous Effects

As described above, the present invention provides a motor having an integral stator core that is obtained by compression-molding amorphous metal powder, soft magnetic powder, or a mixture of amorphous metal powder and soft magnetic powder, thereby reducing a core loss to thus reduce a mold manufacturing cost and a manufacturing cost, and to thus simplify a manufacturing process.

In addition, in the case of a motor having an integral stator core according to the present invention, coil winding grooves are formed on the upper and lower surfaces as well as the left and right surfaces of a yoke around which coils are wound in the stator core, to thereby reduce height of the stator core and to thus enable the motor to be slimmed

In addition, in the case of a motor having an amorphous core according to the present invention, a yoke and flanges in a stator core are separately manufactured to then be mutually assembled to make a stator core, to thereby manufacture shape of the stator core in various forms.

### DESCRIPTION OF DRAWINGS

FIG. 1 is a cross-sectional view of a motor in accordance with an embodiment of the present invention.

FIG. 2 is a plan view of a motor in accordance with an embodiment of the present invention.

FIG. 3 is a cross-sectional view of a rotor in accordance with an embodiment of the present invention.

FIG. 4 is a cross-sectional view of a stator in accordance with an embodiment of the present invention.

FIG. 5 is a perspective view of a stator core according to an embodiment of the present invention.

FIG. 6 is a cross-sectional view of a motor in accordance with another embodiment of the present invention.

FIG. 7 is a perspective view of a stator core according to a modified embodiment of the present invention.

FIG. 8 is a perspective view of a stator core according to another modified embodiment of the present invention.

### BEST MODE

Hereinbelow, preferred embodiments of the present invention will be described in detail with reference to the accompanying drawings. In this process, the size and shape of the components illustrated in the drawings may be shown exaggeratedly for clarity and convenience of explanation. Further, by considering the configuration and operation of the present invention, the specifically defined terms can be changed according to a user or operator's intention or custom. The definitions of these terms need to be made based on the content all over the specification herein.

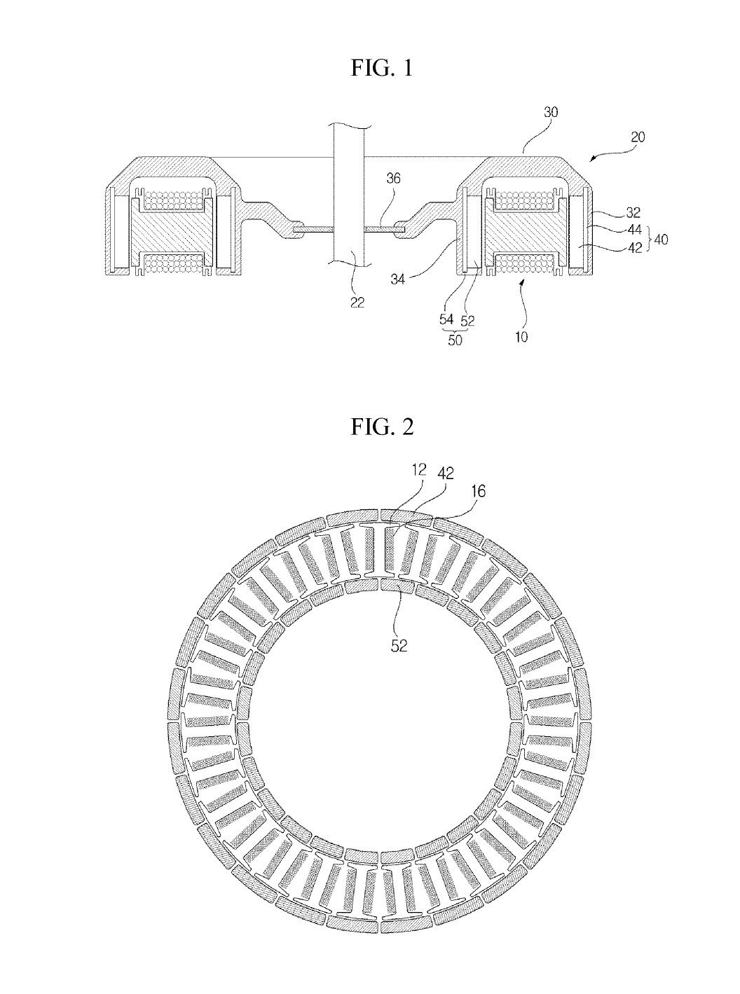

FIG. 1 is a cross-sectional view of a motor in accordance with an embodiment of the present invention. FIG. 2 is a plan view of a motor in accordance with an embodiment of the present invention.

Referring to FIGS. 1 and 2, the motor in accordance with an embodiment of the present invention includes a stator 10, and a rotor 20 disposed with a certain gap from the stator 10 on the inner circumferential surface of the outer circumferential surface of the stator 10 and connected to a rotating shaft 22.

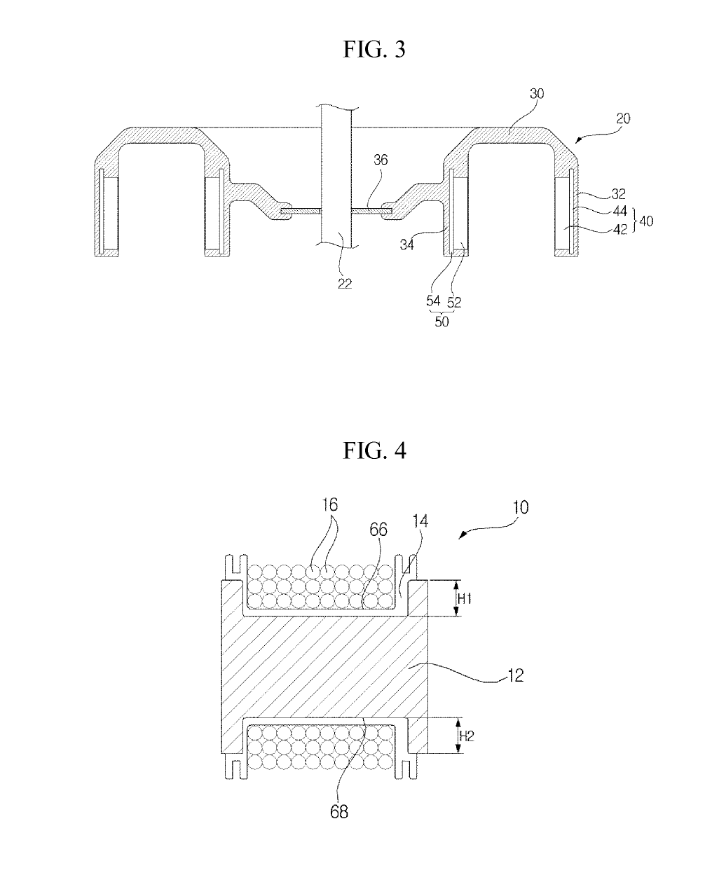

As shown in FIG. 3, the rotor 20 includes: a rotor support 30 to which the rotating shaft 22 is supported; an outer rotor 40 that is mounted at an outer side of the rotor support 30 and is arranged with a gap on an outer circumferential surface of the stator 10; and an inner rotor 50 that is mounted at an inner side of the rotor support 30 and is arranged with a gap on an inner circumferential surface of the stator 10.

The rotor support 30 includes: a first mounting portion 32 in which the outer rotor 40 is mounted; a second mounting portion 34 that is connected to the first mounting portion 32 in which the inner rotor 50 is mounted; and a metal plate 36 that is located at the center of the rotor support 30 and with which the rotating shaft 22 is spline-coupled.

The outer rotor 40 includes: a first magnet 42 disposed with a predetermined gap on the outer circumferential surface of the stator 10; and a first back yoke 44 that is mounted on the back of the first magnet 42.

In addition, the inner rotor 50 includes: a second magnet 52 disposed with a predetermined gap on the inner circumferential surface of the stator 10; and a second back yoke 54 that is mounted on the back of the second magnet 42.

The rotor 20 is manufactured by integrally insert-molding the rotor support 30 at a state where the outer rotor 40, the inner rotor 50, and the metal plate 36 are inserted in a mold. Here, the rotor support 30 may be insert-molded with a BMC (Bulk Molding Compound) molding material, or insert-molded with a plastic material.

As shown in FIG. 4, the stator 10 includes: a number of annularly arranged stator cores 12; insulative bobbins 14 that are surrounded on the outer circumferential surfaces of the stator cores 12; and coils 16 wound on an outer circumferential surface of each bobbin 14.

According to a method of making a large number of stator cores annularly, the stator cores in which the bobbins and the coils are mounted are radially arranged, and then insert-molded with a BMC (Bulk Molding Compound) molding material, to thereby form the stator cores integrally.

Besides, according to another method of making a large number of stator cores annularly, the stator cores are radially fixed on a lower fixing plate and an upper fixing plate is fixed on the upper surfaces of the stator cores, to then mutually couple between the lower fixing plate and the upper fixing plate.

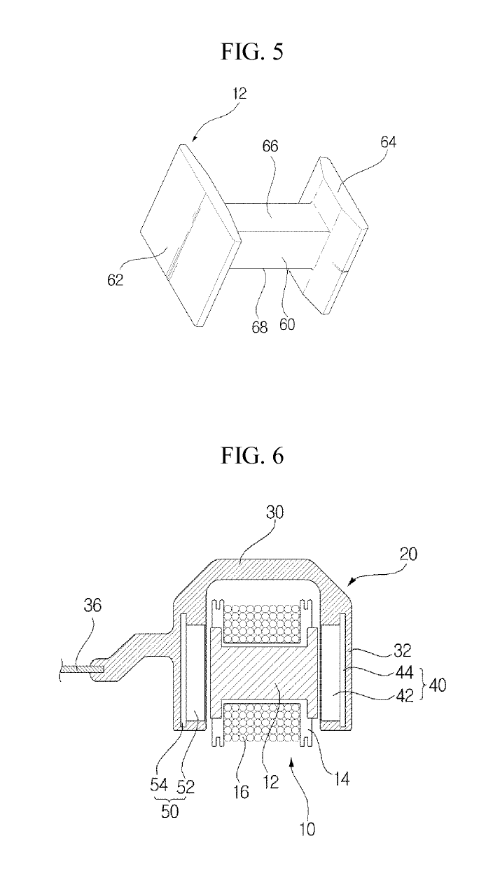

As shown in FIG. 5, each of the stator cores 12 includes: a yoke 60 around which the coils 16 are wound; a first flange 62 formed on one end of the yoke 60, and disposed opposite to the outer rotor 40; and a second flange 64 formed on the other end of the yoke 60 and disposed opposite to the inner rotor 50.

The stator cores 12 are integrally formed by compression-molding amorphous metal powder in a mold. That is, each of the stator cores 12 according to this embodiment is not of a structure of laminating a plurality of iron pieces, but is of an integral core structure of molding or compression-molding amorphous metal powder.

Thus, the stator cores 12 can be easily manufactured by molding or compression-molding amorphous metal powder. Further, by using the bobbins 14, the annular assembly of the stator cores 12 can be easily solved.

Then, the stator cores 12 may be molded by mixing amorphous metal powder with binders, or by mixing amorphous metal powder, crystalline metal powder whose soft magnetic properties are excellent, and binders, at a predetermined mixing ratio. In this case, when compared to a case of using the amorphous metal powder of 100%, a case that metal powder is mixed at a predetermined ratio can eliminate a high-pressure sintering difficulty, and can increase a magnetic permeability.

Then, the stator cores 31 may be prepared by compression-molding the soft magnetic powder alone.

Coils are wound around the outer circumferential surface of the yoke 60, in which coil winding grooves 66 and 68 are formed on the upper and lower surfaces as well as the left and right surfaces of the yoke 60. That is, the height of the yoke 60 is made smaller, and the coil winding grooves 66 and 68 are formed on the upper and lower surfaces as well as the left and right surfaces of the yoke 60. Accordingly, more coils 16 can be wound according to the coil winding grooves 66 and 68 formed on the yoke 60. As a result, in the case that coils are wound in the same amount and with the same thickness of coils, the height of the yoke 60 can be reduced, to thus reduce the total height of the motor.

The coil winding grooves 66 and 68 include: a first coil winding groove 66 that is formed on the upper surface or the left surface of the yoke 60 and is formed concavely inwardly by a height H1 from the upper surface of the first flange 62; and a second coil winding groove 68 that is formed on the lower surface or the right surface of the yoke 60 and is formed concavely inwardly by a height H2 from the upper surface of the second flange 64.

Further, as shown in FIG. 6, since the coil winding grooves 66 and 68 are formed on the stator core 12, more coils 16 can be wound according to the coil winding grooves 66 and 68, to thereby improve performance of the motor.

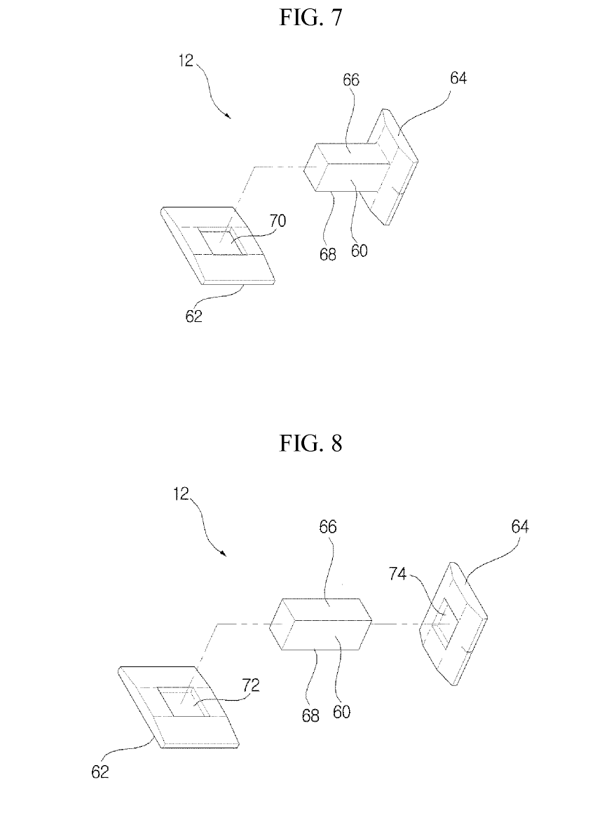

As shown in FIGS. 7 and 8, the stator core 12 can be prepared by separately preparing flanges 62 and 64 and the yoke 60, and then bonding between the flanges 62 and 64 and the yoke 60.

For example, as illustrated in FIG. 7, the first flange 62 is prepared by compression-molding amorphous metal powder or soft magnetic powder, and the yoke 60 and the second flange 64 are prepared by compression-molding amorphous metal powder or soft magnetic powder. Then, bonding is executed between the first flange 62 and the yoke 60, to thereby assemble the stator core 12.

In this case, an insertion hole 70 is formed in the first flange 62, and one end of the yoke 60 is inserted into the insertion groove 70, to thus prepare the stator core 12.

Then, as shown in FIG. 8, the first flange 62 and the second flange 64 are prepared by compression-molding amorphous metal powder or soft magnetic powder, and the yoke 60 are prepared by compression-molding metal powder or soft magnetic powder. Then, one end of the yoke 60 is inserted into a first insertion groove 72 formed in the first flange 62, and the other end of the yoke 60 is inserted into a second insertion groove 74 formed in the second flange 64. Then, bonding is executed between the first and second flanges 62 and 64 and the yoke 60, to thereby assemble the stator core 12.

As described above, the flanges 62 and 64 and the yoke 60 are separately prepared and thus amorphous metal powder or the soft magnetic powder are easily compression-molded in a mold, and the shape of the stator cores can be manufactured in various forms.

Hereinbelow, a method of manufacturing a stator core according to the present invention will be described. As an example, a method of manufacturing a stator core will be described with respect to a case of using amorphous metal powder.

In the case of a stator core according to the present invention, an amorphous alloy is manufactured into ultra-thin type amorphous alloy ribbons or strips of 30 μm or less by using a rapid solidification processing (RSP) method through a melt spinning process, and then the ultra-thin type amorphous alloy ribbons or strips are pulverized, to thus obtain amorphous metal powder. Here, the obtained amorphous metal powder has a size in the range of 1 to 150 μm.

In this case, the amorphous alloy ribbons or strips may be heat-treated at 400-600° C. under a nitrogen atmosphere, so as to have a nanocrystalline microstructure that can promote high permeability.

In addition, the amorphous alloy ribbons or strips may be heat-treated at 100-400° C. in the air, to improve the pulverization efficiency.

Of course, it is possible to use spherical powder obtained as the amorphous metal powder by an atomization method other than the pulverization method of the amorphous alloy ribbons or strips.

For example, any one of a Fe-based, Co-based, and Ni-based amorphous alloy may be used as the amorphous alloy. Preferably, a Fe-based amorphous alloy is advantageous in terms of price. The Fe-based amorphous alloy is preferably any one of Fe—Si—B, Fe—Si—Al, Fe—Hf—C, Fe—Cu—Nb—Si—B, and Fe—Si—N. In addition, the Co-based amorphous alloy is preferably any one of Co—Fe—Si—B and Co—Fe—Ni—Si—B.

Thereafter, the pulverized amorphous metal powder is classified depending on the size of the particle, and then mixed in a powder particle size distribution having optimal composition uniformity. In this case, since the pulverized amorphous metal powder is made up in a plate shape, a packing density is lowered below the optimal condition, when the amorphous metal powder is mixed with a binder to then be molded into a shape of components. Accordingly, the present invention uses a mixture of a predetermined amount of spherical soft magnetic powder with plate-shaped amorphous metal powder, to thus increase the molding density, in which the spherical soft magnetic powder is made of spherical powder particles, to promote improvement of magnetic properties, that is, permeability.

For example, one of MPP powder, HighFlux powder, Sendust powder, and iron powder, or a mixture thereof may be used as the spherical soft magnetic powder that may promote improvement of the permeability and the packing density.

A binder mixed in the mixed amorphous metal powder is, for example, a thermosetting resin such as sodium silicate called water glass, ceramic silicate, an epoxy resin, a phenolic resin, a silicone resin or polyimide. In this case, the maximum mixing ratio of the binder is preferably 20 wt %.

The mixed amorphous metal powder is compression-molded into a desired shape of cores or back yokes by using presses and molds at a state where binders and lubricants have been added in the amorphous metal powder. When a compression-molding process is achieved by presses, a molding pressure is preferably set to 15-20 ton/cm².

After that, the molded cores or back yokes are sintered in the range of 300-600° C. for 10-600 min to implement magnetic properties.

In the case that the heat-treatment temperature is less than 300° C., heat treatment time increases to thus cause a loss of productivity, and in the case that heat-treatment temperature exceeds 600° C., deterioration of the magnetic properties of the amorphous alloys occurs.

In addition, in the present invention, only soft magnetic powder can be compression-molded other than the amorphous metal powder

As described above, since amorphous metal powder or soft magnetic powder is compression-molded, in the present invention, the stator cores of complex shapes are easily molded, and the crystalline metal powder having excellent soft magnetic properties is added in the amorphous metal powder, to thereby promote improvement of the magnetic permeability and improvement of the molding density at the time of compression-molding.

Furthermore, when the stator cores are manufactured, in the present invention, the stator cores are molded by using amorphous metal powder or soft magnetic powder, or by a mixture of crystalline metal powder with amorphous metal powder, to thereby minimize an eddy current loss (or a core loss), and to thus be appropriate to be used as a high speed motor of over 50,000 rpm.

In the case of the above-described embodiments, a double rotor structure where the outer and inner rotors are disposed at both sides of the stator has been described, for example. However, the present invention can be applied to a structure of a combination of a single stator and a single rotor.

In addition, the present invention can be extended and applied to a structure where double stators are disposed at both sides of a single rotor, or double rotors are combined, that is, a structure of three rotors that are provided between a pair of stators and in the outer side of the pair of stators.

According to the motor of the present invention, the stator cores can be integrally made by compression-molding amorphous metal powder, soft magnetic powder, or a mixture of amorphous metal powder and soft magnetic powder, to thereby reduce manufacturing costs and to thus be used in various fields requiring driving forces.

In addition, in the case of the motor according to the present invention, the height of the stator core can be reduced, and thus the total height of the motor can be reduced, to thus be used in various fields requiring slim motors.

As described above, the present invention has been described with respect to particularly preferred embodiments. However, the present invention is not limited to the above embodiments, and it is possible for one who has an ordinary skill in the art to make various modifications and variations, without departing off the spirit of the present invention.

Thus, the protective scope of the present invention is not defined within the detailed description thereof but is defined by the claims to be described later and the technical spirit of the present invention.

1. A motor having an integral stator core, the motor comprising:
stators including a plurality of split stator cores that are annularly disposed, bobbins that are surrounded on respective outer circumferential surfaces of the stator cores, and coils wound on an outer circumferential surface of each bobbin; and
rotors that are arranged with a gap from each stator,
wherein each of the stator cores is integrally molded and includes a yoke around which the coils are wound, and a first flange and a second flange that are respectively formed at both ends of the yoke, and
wherein coil winding grooves that are formed at height lower than those of the upper and lower surfaces of the first and second flanges, are formed on the upper and lower surfaces as well as the left and right surfaces of the yoke in order to reduce height of the stator core.

2. The motor having an integral stator core according to claim 1, wherein each rotor comprises:
an outer rotor that is arranged with a gap on an outer circumferential surface of the stator;
an inner rotor that is arranged with a gap on an inner circumferential surface of the stator; and
a rotor support to which the outer rotor and the inner rotor are fixed and to which a rotating shaft is supported.

3. The motor having an integral stator core according to claim 2, wherein the rotor support is integrally formed with the outer rotor and the inner rotor by insert-molding a BMC (Bulk Molding Compound) molding material.

4. The motor having an integral stator core according to claim 1, wherein the coil winding grooves comprise: a first coil winding groove that is formed on top of or on the left surface of the yoke, and that is recessed by a depth H1 inwardly from the top surfaces of the first flange and the second flange; and a second coil winding groove that is formed on bottom of or on the right surface of the yoke, and that is recessed by a depth H2 inwardly from the top surfaces of the first flange and the second flange.

5. The motor having an integral stator core according to claim 1, wherein one or both the first flange and the second flange and the yoke are separately manufactured and mutually assembled.

6. The motor having an integral stator core according to claim 5, wherein an insertion groove into which at least one end of the yoke is inserted is formed in one or both of the first flange and the second flange.

7. The motor having an integral stator core according to claim 1, wherein the stator core is compression-molded by using amorphous metal powder.

8. The motor having an integral stator core according to claim 1, wherein the stator core is compression-molded by using a mixture of amorphous metal powder and spherical soft magnetic powder.

9. The motor having an integral stator core according to claim 1, wherein the stator core is compression-molded by using soft magnetic powder.

10. The motor having an integral stator core according to claim 1, wherein the stator core is formed by arranging the plurality of stator cores radially to then be annularly produced, and then insert-molding a BMC (Bulk Molding Compound) molding material.
